(19) United States
(12) Patent Application Publication
(10) Pub. No.: US 2012/0051186 A1
(43) Pub. Date: Mar. 1, 2012

(54) VALVE CONDITION MONITORING

(76) Inventor: Stuart Guy Holley, Bristol (GB)

(21) Appl. No.: 13/194,509

(22) Filed: Jul. 29, 2011

(30) Foreign Application Priority Data
Aug. 31, 2010 (EP) 10174775.6

(51) Int. Cl. H04B 11/00

(52) U.S. Cl. 367/131

(57) ABSTRACT

A method for monitoring the operation of underwater-located equipment is provided. The method comprises: providing a sensor, the sensor comprising at least one of an acoustic sensor and an accelerometer, locating the sensor proximate the equipment to enable detection by the sensor of acoustic and/or acceleration components produced by the operation of the equipment, and producing electrical output signals in dependence on the detected components.

### BACKGROUND OF THE INVENTION

1. Field of the Invention

The present disclosure relates to a method for monitoring the operation of underwater-located equipment and monitoring apparatus for underwater-located equipment.

2. Description of Related Art

Underwater installations, for example subsea hydrocarbon production wells, typically include vital components which, if they were to fail, could cause significant problems. It is therefore important to monitor the operation of such components, which may not be straightforward for such remotely-located components. For example, an essential method of controlling the flow of production fluid from a subsea wellhead is by utilising at least one valve production control valve, fitted on a subsea tree, which can be opened or shut as required. Generally these valves are hydraulically operated. A known, conventional method of measuring the position of such a valve is by using at least one pressure transducer which is connected to at least one of the hydraulic supply or return line of the valve. The or each transducer is usually fitted at the manifold of the installation, and electrical output signals from the transducer are passed to control means at the surface via an umbilical cable. The actual measured pressure provides an indication of the state of opening or closing of the valve, thus enabling it to be controlled from the surface. Information provided by the pressure transducer also enables a limited assessment to be made of the condition and performance of the valve but this may be affected by various factors, for example fluid temperatures, fluid cavitation and other fluid flow effects and leakages.

Recently, efforts have been made to improve both the range and reliability of information available through the assessment of signals produced from subsea sensors, an example being the condition monitoring system known from co-pending patent application GB 0916421.1.

It has now been found that the use of known pressure transducer monitoring arrangements provide insufficient information to enable a full analysis of equipment, such as a valve as described above, using condition monitoring techniques.

### BRIEF SUMMARY OF THE INVENTION

In view of the above, there is provided a method for monitoring the operation of underwater-located equipment, comprising: providing a sensor, the sensor comprising at least one of an acoustic sensor and an accelerometer; locating the sensor proximate the equipment to enable detection by the sensor of acoustic and/or acceleration components produced by the operation of the equipment; and producing electrical output signals in dependence on the detected components.

According to another aspect, there is provided a monitoring apparatus for underwater-located equipment comprising a sensor for monitoring the operation of the equipment, the sensor comprising at least one of an acoustic sensor and an accelerometer and being operable to output electrical signals in dependence on acoustic and/or acceleration components produced by the operation of the equipment.

Further aspects, advantages and features of the method or apparatus for monitoring underwater-located equipment are apparent from the dependent claims, the description and the accompanying drawings.

Advantages including the following may result from implementation of the method or apparatus for monitoring underwater-located equipment: early identification of potential failures; opportunity to change out deteriorating equipment during normal operations; reduction in unplanned operations; reduced repair costs and downtime; extended equipment life; better control of spare parts, thus reducing costs; reduction in lost production; the possibility of providing valuable information for preventative maintenance systems; and the enabling of optimisation of fluid flow conditions.

### BRIEF DESCRIPTION OF THE SEVERAL VIEWS OF THE DRAWINGS

A full and enabling disclosure including the best mode thereof, to one of ordinary skill in the art, is set forth more particularly in the remainder of the specification, including reference to the accompanying figures wherein:

FIG. 1 schematically shows an embodiment of the present invention using an acoustic sensor; and

FIG. 2 schematically shows a second embodiment of the present invention using an accelerometer.

### DETAILED DESCRIPTION OF THE INVENTION

Reference will now be made in detail to the various embodiments, one or more examples of which are illustrated in each figure. Each example is provided by way of explanation and is not meant as a limitation. For example, features illustrated or described as part of one embodiment can be used on or in conjunction with other embodiments to yield yet further embodiments. It is intended that the present disclosure includes such modifications and variations.

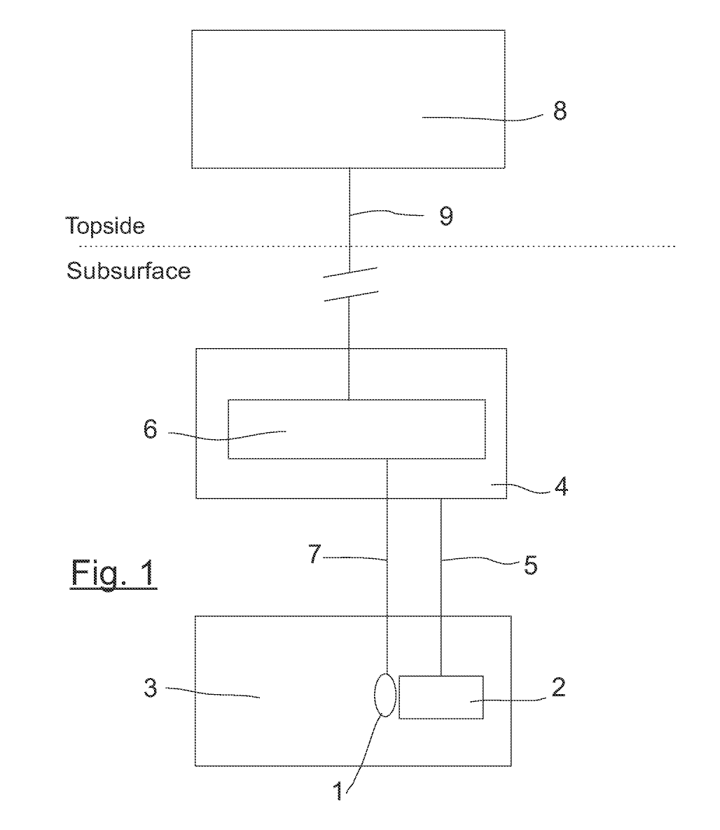

A first embodiment of the present invention, using an acoustic sensor, is schematically shown in FIG. 1. Here the equipment being monitored is a production control valve located on a subsea tree of a hydrocarbon production well. An acoustic sensor, in this example a hydrophone 1, is fitted to a subsea production control valve 2, which is mounted on a subsea tree 3. The valve 2 is controlled by operating signals received from a subsea control module (SCM) 4 via line 5. The valve 2 may be hydraulically or electrically operated.

The hydrophone is electrically connected to a subsea electronics module (SEM) 6, housed in the SCM 4, via a cable 7. The SCM 4 and SEM 6 are in communication with a well head control system 8, which is provided at a surface location (referred to as “topside” in the art), for example onshore, or at a vessel or platform, via an umbilical cable 9, as is known in the art.

The hydrophone 1 is adapted to capture the acoustic signature of the production control valve 2 and convert the data to an associated electrical signal. The term “acoustic signature” as used herein refers to the frequency response as measured over a period of time associated with the operation of the valve. The electrical signal is passed via the cable 7 to SEM 6. The SEM 6 in turn transfers this via umbilical cable 9 to the wellhead control system 8 for data analysis.

The data analysis performed within the wellhead control system utilises pattern recognition algorithms to compare the received data against a database which contains historical data. Typically the historical data relate to valve position as well as fault condition acoustic signatures. By suitable comparison, the position of the valve 2 may be determined. In addition, the processing may recognise whether there is abnormal behaviour, i.e. a fault, of the valve. The processing is performed in conjunction with feedback from the other control system information, for example monitoring information relating to other equipment or components at the tree.

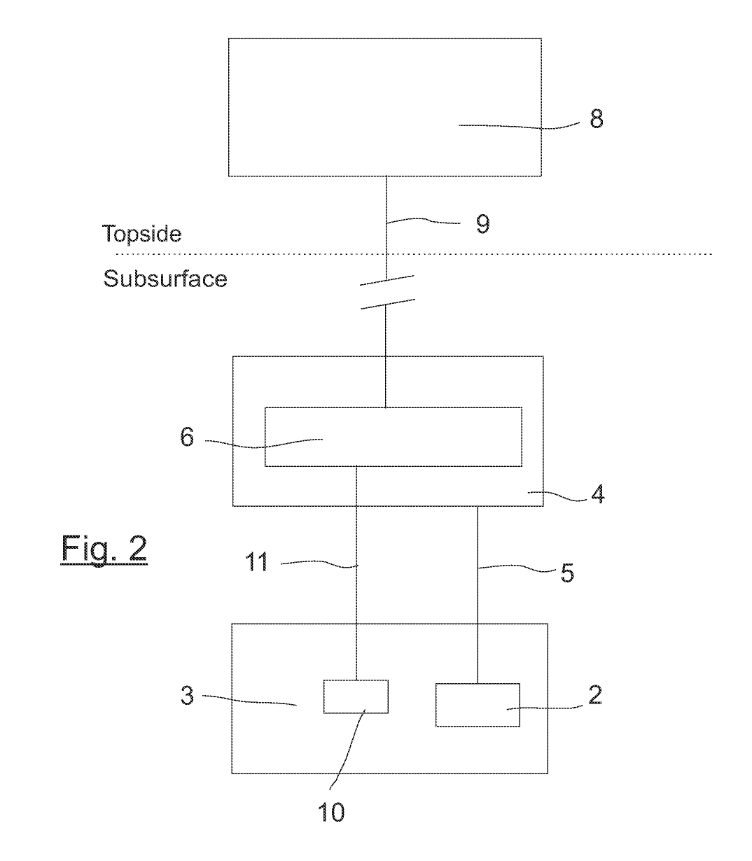

FIG. 2 shows a second embodiment of the present invention, which has much similarity to the first embodiment and like components are denoted with the same reference numerals. However, in this embodiment the sensor used to monitor the valve operation is an accelerometer 10, which is connected to SEM 6 via a cable 11. The accelerometer 10 can capture continuous movement signals, caused by physical actuation of valve 2. The acceleration data captured by accelerometer 10 may be compared with known acceleration signatures of valve states and also be used to determine the opening and closing state of the valve.

In this way, an acoustic sensor or accelerometer is employed, which may be mounted on an underwater host facility, for example a subsea well tree, and capable of continuously capturing acoustic/acceleration signals and the associated acoustic/acceleration frequency spectrum. These may then be relayed to a surface location, where the data can be compared with known acoustic/acceleration signatures for the relevant equipment, e.g. various valve states, and used to determine the state of operation of the equipment, e.g. opening and closing of the valve.

The condition, amount of degradation and performance of the equipment can be measured by using pattern recognition techniques, to predict condition and deduce the causes of faults and performance loss. This is achieved by comparing signatures with historical data and modelling results of various equipment conditions. The information can be used to determine the optimum time to carry out maintenance and this in turn will reduce down time for carrying out unexpected repairs. This data can be used in conjunction with information on the control system operations to detect and monitor subsea equipment condition and performance.

The present technique enables monitoring of subsea hardware and in the case of fluid flow for example could be used to confirm valve and choke movement, monitor changes in operating profile, detect cavitations in fluid flow and other flow regimes, detect fluid leakage and monitor the flow in fluid pipelines. The technique has general application to subsea equipment generating a measurable frequency spectrum/acceleration.

Several pieces of equipment, for example valves and chokes, may be involved in controlling the fluid flow from a well and further devices such as high integrity pipeline protection valves, may be monitored to ensure operational safety. Each of these could be fitted with an acoustic sensor/accelerometer, or alternatively a single acoustic sensor/accelerometer may be used to monitor multiple items of equipment (e.g. valves/chokes).

The above-described embodiments are exemplary only, and other possibilities and alternatives within the scope of the present invention will be apparent to those skilled in the art. For example, although the examples described above use only a single sensor, it is also possible to use more than one, for example both an accelerometer and an acoustic sensor may be used, or indeed a plurality of sensors of either type and in any combination. The data from the individual sensors may be collated by the wellhead control system, and used to improve accuracy or reliability of monitoring. Furthermore, the use of additional sensors provides a level of redundancy, such that monitoring may still be available in the event that one sensor fails.

The monitoring system could be used to monitor any item of equipment which produces in use an acoustic output or movement.

The or each acoustic sensor/accelerometer could be located on the tree, rather than on a specific item of equipment. This would enable output from a plurality of items to be monitored.

What is claimed is:

1. A method for monitoring the operation of underwater-located equipment, comprising:
providing a sensor, the sensor comprising at least one of an acoustic sensor and an accelerometer;
locating the sensor proximate the equipment to enable detection by the sensor of acoustic and/or acceleration components produced by the operation of the equipment; and
producing electrical output signals in dependence on the detected components.

2. The method according to claim 1, wherein the underwater equipment is located at a subsea well tree.

3. The method according to claim 2, wherein the sensor is located at the tree.

4. The method according to claim 2, wherein the sensor is fitted to the equipment.

5. The method according to claim 1, wherein the equipment comprises a valve.

6. The method according to claim 5, wherein the valve comprises a production control valve.

7. The method according to claim 1, wherein the sensor is connected to a subsea electronics module for sending electrical output signals thereto.

8. The method according to claim 1, further comprising passing the electrical output signals to a surface location for processing.

9. The method according to claim 1, wherein the sensor is adapted for detecting the acoustic or acceleration signature of the equipment.

10. The method according to claims 1, further comprising comparing the output signal with a historical database.

11. A monitoring apparatus for underwater-located equipment, the monitoring apparatus comprising: a sensor for monitoring the operation of the equipment, the sensor comprising at least one of an acoustic sensor and an accelerometer and being operable to output electrical signals in dependence on acoustic and/or acceleration components produced by the operation of the equipment.

12. The apparatus according to claim 11, wherein the underwater equipment is located at a subsea well tree.

13. The apparatus according to claim 12, wherein the sensor is located at the tree.

14. The apparatus according to claim 12, wherein the sensor is fitted to the equipment.

15. The apparatus according to claim 11, wherein the equipment comprises a valve.

16. The apparatus according to claim 15, wherein the valve comprises a production control valve.

17. The apparatus according to claim 11, wherein the sensor is connected to a subsea electronics module for sending electrical output signals thereto.

18. The apparatus according to claim 11, wherein the sensor is adapted for detecting the acoustic or acceleration signature of the equipment.
